(19) United States
(12) Patent Application Publication
(10) Pub. No.: US 2025/0173644 A1
(43) Pub. Date: May 29, 2025

(54) DISPATCH MANAGEMENT DEVICE

(71) Applicant: TOYOTA JIDOSHA KABUSHIKI KAISHA, Toyota-shi Aichi-ken (JP)

(72) Inventor: Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 18/952,511

(22) Filed: Nov. 19, 2024

(30) Foreign Application Priority Data
Nov. 29, 2023 (JP) 2023-201898

(51) Int. Cl. G06Q 10/0631; G06Q 50/40

(52) U.S. Cl. CPC G06Q 10/063112; G06Q 50/40

(57) ABSTRACT

The vehicle dispatch management device includes a processor configured to: determine an influence index value representing an influence degree on a decrease in durability based on a driving plan included in a dispatch request, set a priority for each of a plurality of candidate vehicles so that the priority becomes lower, as durability of the candidate vehicle represented by a durability index of the candidate vehicle is lower, in response to the influence index value, and determine a vehicle to be dispatched from among the plurality of candidate vehicles in response to the priority of each of the plurality of candidate vehicles.

### CROSS-REFERENCE TO RELATED APPLICATIONS

This application claims priority to Japanese Patent Application No. 2023-201898 filed Nov. 29, 2023, the entire contents of which are herein incorporated by reference.

### FIELD

The present disclosure relates to a dispatch management device for dispatching a vehicle.

### BACKGROUND

A technique for improving dispatch efficiency has been proposed (see Japanese Unexamined Patent Publication JP2021-22260A). The dispatch management control device disclosed in JP2021-22260A searches candidate vehicles that meet a condition of order information including position information of a dispatch position, notifies each candidate vehicle of occurrence of a dispatch order, acquires answer information on whether or not to accept the dispatch order from each candidate vehicle, and notifies one of the candidate vehicles that can be accepted of the dispatch instruction.

### SUMMARY

A total travel distance of a vehicle used for a taxi service may be significantly longer than a total travel distance of a vehicle owned by an individual. Therefore, the durability of the vehicle used in the taxi service may be deteriorated depending on the use state of the vehicle. On the other hand, in the above-described technique, the durability of the vehicle is not taken into consideration when determining the vehicle to be dispatched. Therefore, in some cases, a vehicle in which a problem may occur due to a decrease in durability may be dispatched to a user who has a driving plan in which a decrease in durability is a concern.

Accordingly, it is an object of the present disclosure is to provide a dispatch management device that can facilitate to dispatch a vehicle without a problem of durability to a user who has a driving plan in which deterioration of durability is a concern.

According to one aspect of the present disclosure, a dispatch management device is provided. The dispatch management device includes a processor configured to: determine an influence index value representing an influence degree on a decrease in durability based on a driving plan included in a dispatch request, set a priority for each of a plurality of candidate vehicles so that the priority becomes lower, as durability of the candidate vehicle represented by a durability index of the candidate vehicle is lower, in response to the influence index value, and determine a vehicle to be dispatched from among the plurality of candidate vehicles in response to the priority of each of the plurality of candidate vehicles.

In one embodiment, the durability index of each of the plurality of candidate vehicles includes a total travel distance, and for each of the plurality of candidate vehicles, the processor lowers the priority of the candidate vehicle as the total travel distance of the candidate vehicle is longer.

In one embodiment, the processor determines the influence index value so that the priority becomes lower as an elevation difference or a gradient in a planned traveling route indicated by the driving plan is larger.

In one embodiment, the processor determines the influence index value so that the priority becomes lower as a difference between a target arrival time and a scheduled departure time indicated by the driving plan is smaller.

In one embodiment, the processor determines the influence index value such that the priority is lower as an expected number of passengers indicated by the driving plan increases.

The dispatch management device according to the present disclosure has an effect of being able to facilitate to dispatch a vehicle without a problem of durability to a user who has a driving plan in which deterioration of durability is a concern.

### BRIEF DESCRIPTION OF DRAWINGS

FIG. 1 is a schematic configuration diagram of a dispatch management system in which a dispatch management device according to an embodiment is implemented.

FIG. 2 is a schematic configuration diagram of a server, which is an example of a dispatch management device.

FIG. 3 is a functional block diagram of a processor of a server related to a dispatch management process.

FIG. 4 is a diagram illustrating an example of setting an item priority related to durability based on individual influence index values and total travel distances of a candidate vehicle.

FIG. 5 is an operation flowchart of the dispatch management process.

### DESCRIPTION OF EMBODIMENTS

Hereinafter, a dispatch management device, a dispatch management method, a computer program for dispatch management, and a dispatch management system including the dispatch management device will be described with reference to the drawings. The dispatch management device determines a vehicle to be actually dispatched from among a plurality of candidate vehicles in consideration of a driving plan of a user who desires dispatch. That is, the dispatch management device calculates an influence index value in response to a degree of influence on a decrease in durability on the basis of an item that is a factor of a decrease in durability of the vehicle, which is indicated in the driving plan. Then, the dispatch management device sets a priority level for each candidate vehicle on the basis of the total travel distance and the influence index value of the candidate vehicle so that the priority level becomes lower as the total travel distance becomes longer. Then the dispatch management device determines, from among the plurality of candidate vehicles, a vehicle to be actually dispatched based on the priority level set for each candidate vehicle.

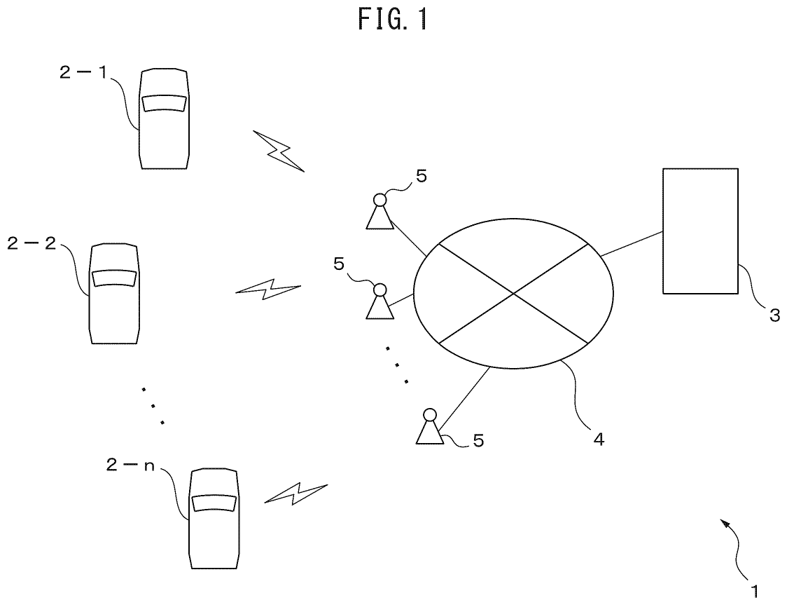

FIG. 1 is a schematic configuration diagram of a dispatch management system in which a dispatch management device according to an embodiment is implemented. The vehicle dispatch management system 1 includes a plurality of vehicles 2-1 to 2-n that can be dispatched (n is an integer of 2 or more), and a server 3 that is an example of the dispatch management device. Each of the plurality of vehicles 2-1 to 2-n can communicate with the server 3 via a communication network 4 and a wireless base station 5 connected to the communication network 4 via a gateway (not shown). The server 3 is connected to the communication network 4 via, for example, a gateway (not shown). The server 3 determines a vehicle to be dispatched from among the plurality of vehicles 2-1 to 2-n in response to a dispatch request from the user and transmits a pick-up instruction to the determined vehicle.

The dispatch management system 1 may further include one or more portable terminals (not shown) capable of communicating with the server 3 via the wireless base station 5 and the communication network 4. Such a mobile terminal may be, for example, a mobile phone carried by a user. Then, the mobile terminal transmits a dispatch request including identification information of the user and the like to the server 3 via the wireless base station 5 and the communication network 4 in accordance with the user's operation. The server 3 may receive a dispatch request from a server (not shown) for user information management via the communication network 4.

In addition to the identification information of the user, the dispatch request may include information indicating a driving plan including a planned boarding location of the user, a planned getting-out location of the user, and a planned traveling route from the planned boarding location to the planned getting-out location. Further, the driving plan may include at least one of an expected number of passengers, a number of children among the expected number of passengers, an expected departure time, and a target arrival time. Further, the dispatch request may include information indicating at least one of a desired vehicle type and a desired option.

Each of the plurality of vehicles 2-1 to 2-n may be a vehicle capable of providing a mobility service such as a taxi service, and may be an autonomous vehicle. To this end, each of the plurality of vehicles 2-1 to 2-n includes, for example, a wireless communication terminal (not shown), an electronic control unit (ECU, not shown), and a positioning device (not shown). The wireless communication terminal has a wireless communication function and is configured to be able to communicate with the wireless base station 5. The ECU controls autonomous driving of the vehicle and controls each unit of the vehicle. The positioning device is configured to measure the position of the vehicle and may include, for example, a receiver for receiving a Global Positioning System (GPS) signal and computing circuitry for calculating the position of the vehicle from GPS signals. Further, each of the plurality of vehicles 2-1 to 2-n may include a storage device (not shown) for storing map information, and a navigation system (not shown) for determining a traveling route from the present position of the vehicle to the travel destination. Furthermore, each of the plurality of vehicles 2-1 to 2-n may have an external sensor (not shown) for obtaining information about the surroundings of the vehicle. The external sensor may be, for example, a camera provided to capture an image of the surroundings of the vehicle, or a ranging sensor such as a radar or a LiDAR sensor for detecting a distance to an object present around the vehicle. The wireless communication terminal, the positioning device, the storage device, the navigation system, and the external sensor are communicably connected to ECU via an in-vehicle network (not shown) compliant with a predetermined standard provided in the vehicle.

In each of the plurality of vehicles 2-1 to 2-n, when a pick-up instruction is notified from the server 3 via the wireless communication terminal, the ECU returns a signal indicating that the pick-up instruction has been received to the server 3 via the wireless communication terminal. In a case where the pick-up instruction cannot be fulfilled, such as a case where the remaining fuel or the remaining capacity of the battery of the vehicle that has received the pick-up instruction is less than a predetermined lower limit threshold, the ECU may return a signal indicating that fulfilling of the pick-up instruction is impossible to the server 3 via the wireless communication terminal. In addition, ECU notifies the navigation system of the planned boarding location designated by the pick-up instruction when there is no reason to be unable to fulfill the pick-up instruction. Then, the navigation system refers to the map information and searches a traveling route from the current position of the vehicle measured by the positioning device to the planned boarding location. Then, the navigation system notifies the ECU of the determined traveling route. The ECU executes autonomous driving control of the vehicle so that the vehicle moves to a planned boarding location along the traveling route. Further, when the user gets into the vehicle, the ECU executes autonomous driving control of the vehicle so as to move along the planned traveling route included in the driving plan to the planned getting-out location. At this time, ECU may control the velocity of the vehicle so that the distance from other objects existing around the vehicle is maintained at a predetermined value or more by using the information about the vehicle surroundings obtained by the external sensor. When the pick-up instruction received from the server 3 includes the traveling route to the planned boarding location, the ECU may execute autonomous driving control of the vehicle so that the vehicle moves to the planned boarding location along the traveling route included in the pick-up instruction. Further, ECU transmits the present position of the vehicle measured by the positioning device, together with the identification information of the vehicle, to the server 3 via the wireless communication terminals at predetermined intervals (for example, 30 seconds, 1 minute, or 5 minutes). Furthermore, when ECU detects that the user has gotten in the vehicle at the planned boarding location notified from the server 3, the ECU transmits a signal indicating that the user has gotten in the vehicle, a position of the vehicle measured by the positioning device and a time obtained from an in-vehicle clock (not shown) when the user got in the vehicle to the server 3 via the wireless communication terminal together with the identification information of the vehicle. Similarly, when the ECU detects that the user has gotten out of the vehicle, the ECU transmits a signal indicating that the user has gotten out of the vehicle, a position of the vehicle measured by the positioning device and a time obtained from the in-vehicle clock when the user got out of the vehicle to the server 3 via the wireless communication terminal together with the identification information of the vehicle. Note that, for example, when the ECU detects that the door of the vehicle has been opened at the planned boarding location by an opening/closing sensor (not shown) of the door, the ECU determines that the user has gotten in the vehicle. Similarly, the ECU determines that the user has gotten out of the vehicle when the opening/closing sensor of the door detects that the door of the vehicle has been opened at the planned getting out location of the user who is getting on the vehicle. The ECU may detect the user gets in or gets out of the vehicle based on a sensor signal obtained by another sensor provided in a passenger compartment of the vehicle, such as a camera for monitoring the passenger compartment or a seating sensor.

Note that each of the plurality of vehicles 2-1 to 2-n may be a vehicle that is manually driven by a driver.

The server 3 selects one or more candidate vehicles in response to the received dispatch request among the plurality of vehicles 2-1 to 2-n, and set a priority for each of the selected candidate vehicles. Then, the server 3 determines a vehicle to be dispatched from among the candidate vehicles based on the priority of each candidate vehicle and transmits a pick-up instruction to the determined vehicle via the communication network 4 and the wireless base station 5.

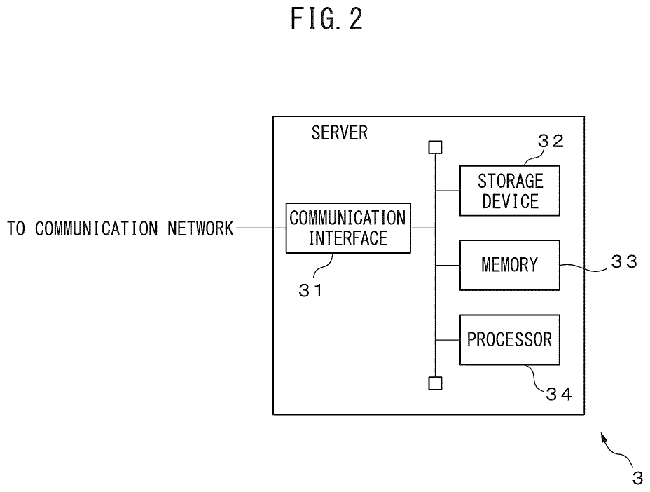

FIG. 2 is a schematic configuration diagram of the server 3, which is an example of the dispatch management device. The server 3 includes a communication interface 31, a storage device 32, a memory 33, and a processor 34. The communication interface 31, the storage device 32, and the memory 33 are connected to the processor 34 via a signal line.

The communication interface 31 is an example of a communication unit, and includes an interface circuit for connecting the server 3 to the communication network 4. The communication interface 31 is configured to be able to communicate with respective wireless communication terminals of a plurality of vehicles 2-1 to 2-n and a mobile terminal carried by a user via the communication network 4 and the wireless base station 5. The communication interface 31 is also configured to be able to communicate with the user information server via the communication network 4. Then, the communication interface 31 passes a signal which is received from the wireless communication terminal of any vehicle via the wireless base station 5 and the communication network 4 and represents the current position of the vehicle etc., to the processor 34. In addition, the communication interface 31 passes a dispatch request received from the mobile terminal or the user information server via the communication network 4 (and the wireless base station 5) to the processor 34. Further, the communication interface 31 transmits a pick-up instruction to a designated vehicle received from the processor 34 to the designated vehicle via the communication network 4 and the wireless base station 5.

The storage device 32 is an example of a storage unit and includes, for example, a Solid State Drive (SSD). The storage device 32 may include a hard disk device, an optical recording medium, and an access device thereof. The storage device 32 stores vehicle information for each of the vehicles 2-1 to 2-n. The vehicle information includes identification information of the vehicle, a type of the vehicle, durability information indicating the durability of the vehicle, a current position of the vehicle, presence or absence of various optional equipment, and a state flag indicating a service providing state (for example, in a standby state, in a pick-up state, or in a user ride state). The storage device 32 also stores map information. Further, the storage device 32 stores various types of data used for setting the influence index value and the priority. Furthermore, the storage device 32 may store a computer program for executing the dispatch management process.

The durability information includes, for example, the total travel distance of the vehicle. Further, the durability information may include the number of days elapsed from the manufacturing date or the registration date of the vehicle, or the number of times of acceleration/deceleration after the manufacturing date or the registration date.

The memory 33 is another example of a storage unit, and includes, for example, a nonvolatile semiconductor memory and a volatile semiconductor memory. The memory 33 stores various data generated during the execution of the dispatch management process, various data received from other devices, and the like.

The processor 34 is an exemplary controller and includes one or more Central Processing Units (CPUs) and peripheral circuitry thereof. The processor 34 may further include other arithmetic circuits such as a logical arithmetic unit or a numerical arithmetic unit. When the processor 34 receives the information indicating the current position of the vehicle from any of the plurality of vehicles 2-1 to 2-n, the processor 34 stores the current position of the vehicle together with the identification information of the vehicle in the storage device 32. Further, the processor 34 transmits a pick-up instruction to any vehicle, and upon receiving a signal indicating that the pick-up instruction has been received from the vehicle, the processor 34 updates the value of the state flag of the vehicle to a value indicating that the vehicle is picking up. Further, when the processor 34 receives a signal indicating that the user has ridden from any of the plurality of vehicles 2-1 to 2-n, the processor 34 updates the value of the status flag of the vehicle to a value indicating that the user is riding. Similarly, when the processor 34 receives a signal from any of the plurality of vehicles 2-1 to 2-n indicating that the user has gotten out, the processor 34 updates the value of the status flag of the vehicle to a value indicating that the vehicle is on standby. Further, upon receiving the dispatch request, the processor 34 executes the dispatch management process.

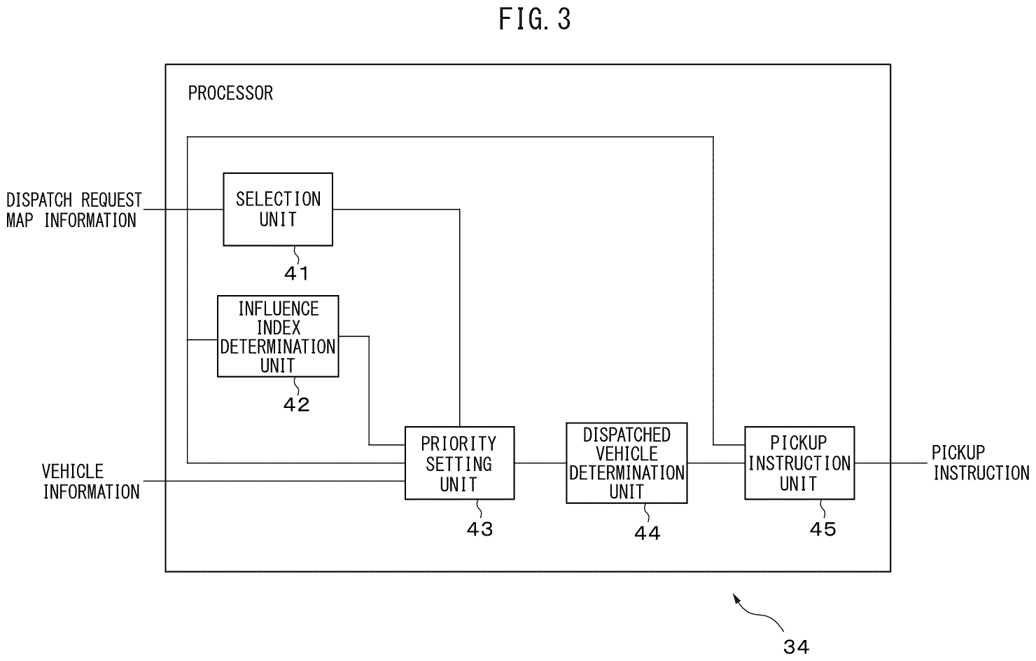

FIG. 3 is a functional block diagram of the processor 34 associated with the dispatch management process. The processor 34 includes a selection unit 41, an influence index determination unit 42, a priority setting unit 43, a dispatched vehicle determination unit 44, and a pickup instruction unit 45. Each of these units included in the processor 34 is, for example, a functional module implemented by a computer program running on the processor 34. Alternatively, each of these units may be a dedicated operating circuit provided in the processor 34.

When the server 3 receives the dispatch request, the selection unit 41 selects one or more vehicles capable of satisfying the dispatch request from among the vehicles 2-1 to 2-n as candidate vehicles. For this purpose, the selection unit 41 refers to the state flags of the respective vehicles and identifies each vehicle of which the value of the state flags indicates the standby state. Further, the selection unit 41 selects, as a candidate vehicle, one or more vehicles that can be moved to the planned boarding location designated by the dispatch request within a predetermined time (for example, within 10 minutes or within 15 minutes) from among the identified vehicles. For this purpose, the selection unit 41 refers to the map information to search for a route from the current position of the vehicle to the planned boarding location by a predetermined route searching method such as the Dijkstra method, and predicts a time required to move to the planned boarding location based on the searched route. The selection unit 41 selects, as a candidate vehicle, a vehicle whose predicted required time is equal to or less than a predetermined time from among the identified vehicles. In a case where the scheduled boarding date and time is included in the dispatch request, the selection unit 41 may select, as a candidate vehicle, a vehicle whose predicted required time is shorter than the period from the current time to the scheduled boarding date and time among the identified vehicles. In addition, in a case where the expected number of passengers is included in the dispatch request, the selection unit 41 excludes each vehicle whose occupant capacity is smaller than the expected number of passengers from the candidate vehicles.

The selection unit 41 notifies the priority setting unit 43 of the identification information of each candidate vehicle.

The influence index determination unit 42 determines one or more influence index values representing an influence degree on a decrease in durability based on a driving plan included in the dispatch request. In the present embodiment, the influence index values are set such that the priority becomes lower as the degree of influence on the decrease in durability is higher.

The influence index determination unit 42 calculates, as one of the influence index values, an elevation difference influence index value representing an influence on a decrease in durability with respect to a difference in elevation of a planned traveling route included in the driving plan. It is expected that the influence on the decrease in durability becomes larger as the difference in elevation for the planned traveling route is larger. Therefore, the influence index determination unit 42 refers to the planned traveling route and the map information to calculate the integrated value of the height difference change in the entire planned traveling route (hereinafter, referred to as the height difference integrated value), the sum of the number of ascents and the number of descents (hereinafter, referred to as the total number of ascents/descents), the absolute value of the maximum uphill gradient in the planned traveling route (hereinafter, referred to as the maximum uphill gradient) and the absolute value of the maximum downhill gradient in the planned traveling route (hereinafter, referred to as the maximum downhill gradient). Then, the influence index determination unit 42 calculates a value obtained by multiplying each of the height difference integrated value x1, the total number of ascents/descents x2, the maximum uphill gradient x3, and the maximum downhill gradient x4 by a corresponding coefficient and then summing them as the elevation difference influence index value DHI, as shown in the following equation.

$$DHI = α * x 1 + β * x 2 + γ * x 3 + δ * x 4 \qquad ( 1 )$$

Here, the parameters α, β, γ, and δ are coefficients corresponding to the height difference integrated value, the total number of ascents/descents, the maximum uphill gradient, and the maximum downhill gradient, respectively, and are set to positive values. That is, as each of the height difference integrated value, the total number of ascents/descents, the maximum uphill gradient, and the maximum downhill gradient increases, the elevation difference influence index value DHI also becomes larger.

Note that the influence index determination unit 42 may calculate the cumulative elevation difference of the ascending or descending in the entire planned traveling route, instead of the height difference integrated value, and use the cumulative elevation difference as the parameter x1 in Equation (1). In addition, the influence index determination unit 42 may calculate the elevation difference influence index value DHI by calculating one, two, or three of the height difference integrated value, the cumulative elevation difference, the total number of ascents/descents, the maximum uphill gradient, and the maximum downhill gradient with the remaining value being 0.

In addition, the influence index determination unit 42 may calculate a travel time influence index value representing an influence on durability regarding a difference between the scheduled departure time and the target arrival time included in the operation plan (hereinafter, referred to as a target travel time). It is expected that the average speed of the vehicle becomes higher and the number of rapid accelerations and decelerations becomes greater as the target travel time is shorter, resulting in a greater impact on the decrease in durability of the vehicle. Therefore, the influence index determination unit 42 sets the travel time influence index value to a larger value as the target travel time is shorter. The influence index determination unit 42 may determine the travel time influence index value by referring to a table representing the relationship between the target travel time and the travel time influence index value stored in advance in the storage device 32. The influence index determination unit 42 may normalize the target travel time by dividing the target travel time by the estimated average vehicle speed of the entire planned traveling route or the total length of the planned traveling route, and set the travel time influence index value based on the normalized target travel time. In this case as well, the influence index determination unit 42 may set the travel time influence index value to a larger value as the normalized target travel time is shorter. The influence index determination unit 42 may refer to the map information to obtain the total length of the planned traveling route. Further, the influence index determination unit 42 refers to the map information to obtain the length and the maximum speed of each section included in the planned traveling route, and can set the estimated average vehicle speed as a value obtained by dividing the total of the values obtained by multiplying the maximum speed of each section by a predetermined coefficient (a value larger than 0 and less than 1, for example, 0.5 to 0.8) and the length of the section by the total length of the planned traveling route. Further, when the server 3 can receive traffic information via the communication network 4, the influence index determination unit 42 may refer to the traffic information to obtain a predicted value of the traffic amount of each section included in the planned traveling route during the scheduled departure time and the target arrival time, and adjust the predetermined coefficient of each section according to the predicted value.

Furthermore, the influence index determination unit 42 may calculate an influence index value for number of passengers, which indicates an influence on durability related to the expected number of passengers included in the driving plan. It is expected that as the number of passengers on the vehicle increases, the load of the vehicle increases, resulting in a greater impact on the decrease in durability of the vehicle. Therefore, the influence index determination unit 42 sets the influence index value for number of passengers to a larger value as the expected number of passengers increases. The influence index determination unit 42 may determine the influence index value for number of passengers by referring to a table that is stored in advance in the storage device 32 and represents a relationship between the expected number of passengers and the influence index value for number of passengers. If the driving plan includes the number of children among the expected number of passengers, the influence index value determining unit 42 may correct the expected number of passengers used for determining the influence index value for number of passengers by subtracting the number obtained by multiplying the number of children by a predetermined coefficient (for example, a value less than 1, for example, 0.4 to 0.6) from the expected number of passengers.

The influence index determination unit 42 does not need to determine all of the above three kinds of influence index values, and may determine one or two of the above three kinds of influence index values. Then, the influence index determination unit 42 outputs each determined influence index value to the priority setting unit 43.

The priority setting unit 43 sets a priority to be dispatched for each candidate vehicle. In the present embodiment, for each candidate vehicle, an item priority is set for each of at least one item, and a weighted sum of the item priorities set for each item is the priority of the candidate vehicle. In the present embodiment, the item for setting the item priority includes an item related to the degree of influence on the decrease in durability of the vehicle (hereinafter, referred to as an item related to the durability).

In addition, the item to which the item priority is set may include any item of a desired vehicle type, the presence or absence of a desired option, and the required time to the planned boarding location, in addition to the item related to the durability. For example, when the desired vehicle type is included in the dispatch request, the priority setting unit 43 refers to the vehicle information of each candidate vehicle and sets the item priority regarding the desired vehicle type for each candidate vehicle. For example, the priority setting unit 43 sets the item priority regarding the desired vehicle type for each candidate vehicle such that the item priority for the candidate vehicle of the same vehicle type as the desired vehicle type is higher than the item priority for the candidate vehicle of the different vehicle type from the desired vehicle type. Similarly, when the desired option is included in the dispatch request, the priority setting unit 43 refers to the vehicle information of each candidate vehicle and sets the item priority regarding the desired option for each candidate vehicle. For example, the priority setting unit 43 sets the item priority for the desired option for each candidate vehicle so that the item priority for the candidate vehicle having the desired option is higher than the item priority for the candidate vehicle having no desired option. Furthermore, the priority setting unit 43 sets the item priority regarding the required time for each candidate vehicle so that the item priority becomes higher as the required time to the planned boarding location is shorter. When the item priority for items other than durability is not set, the item priority for durability is the priority itself.

Hereinafter, the details of item priority setting related to durability will be described below. The priority setting unit 43 sets, for each candidate vehicle, an item priority related to durability such that the item priority related to durability becomes lower, as the durability of the candidate vehicle represented by a durability index of the candidate vehicle is lower, in accordance with the individual influence index values. In the present embodiment, the priority setting unit 43 uses, as the durability index of each candidate vehicle, the total travel distance of the candidate vehicle. That is, it is supposed that the durability of the candidate vehicle is lower as the total travel distance of the candidate vehicle is longer.

In the present embodiment, for each candidate vehicle, the priority setting unit 43 sets a value obtained by subtracting, from a predetermined constant value, the sum of values obtained by multiplying the individual influence index values by a coefficient in response to the total travel distance of the candidate vehicle, as the item priority PD regarding durability, as shown in the following equation.

$$PD = A - \{ DHI * y 1 + RTI * y 2 + NPI * y 3 \} \qquad ( 2 )$$

Herein, the parameters DHI, RTI and NPI are the elevation difference influence index value, the travel time influence index value, and the influence index value for number of passengers, respectively. The parameters y1, y2 and y3 are coefficients determined according to the total travel distance of the candidate vehicles of interest, and is a value obtained by inputting the total travel distance to a function set in advance for each of the elevation difference influence index value, the travel time influence index value, and the influence index value for number of passengers. In the present embodiment, the function related to each influence value can be a function that monotonically increases with respect to the total travel distance. However, these functions are not limited to the first-order function, and may be a second-order or higher-order function, an exponential function, a logarithmic function, or a combination function thereof. Alternatively, the parameters y1 to y3 may be determined according to a table representing a relation between the total travel distance and the parameters y1 to y3. Further, the parameter A is a constant. As can be seen from the equation (2), as the higher the total travel distance of the candidate vehicle is longer, the item priority related to durability PD of the candidate vehicle becomes smaller. Further, as the elevation difference influence index value, the travel time influence index value, and the influence index value for number of passengers are larger, respectively, the item priority related to durability PD becomes smaller. As a result, as the influence of the driving plan on the decrease in durability is higher, the priority of the candidate vehicle in which the decrease in durability is concerned becomes lower. Note that the present disclosure is not limited to this example, and the priority setting unit 43 may determine the item priority related to durability by referring to a table representing the relationship between each influence index value, the total travel distance, and the item priority related to durability. In this case as well, the table is set so that the item priority related to durability becomes a smaller value as the total travel distance of the candidate vehicle is longer or as the individual influence index values are larger, and the table may be stored in advance in the storage device 32.

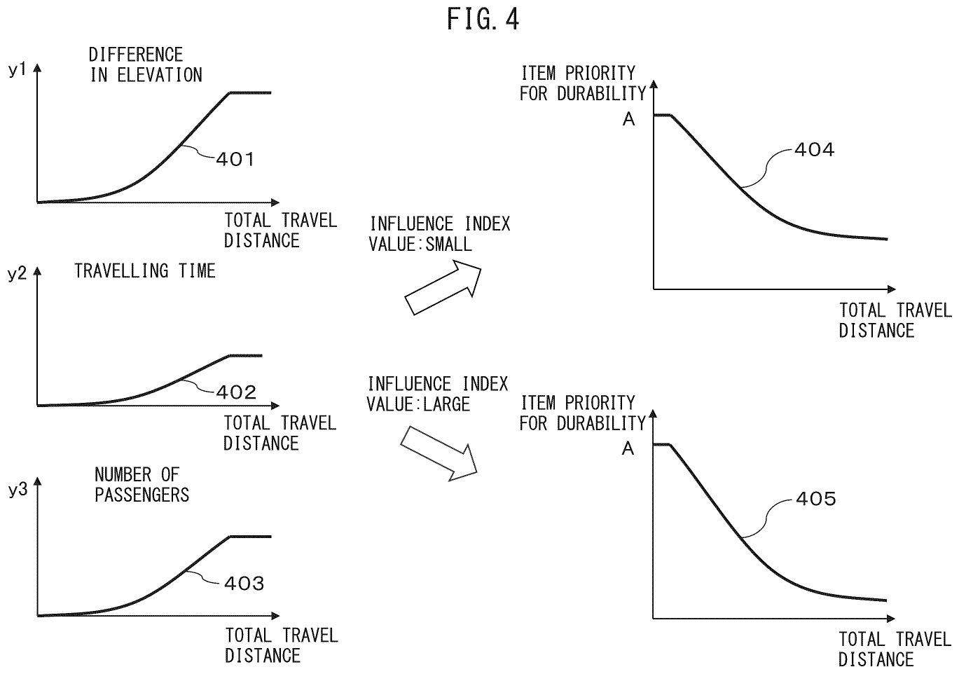

FIG. 4 is a diagram illustrating an example of setting an item priority related to durability based on individual influence index values and a total travel distance of a candidate vehicle. In FIG. 4, graphs 401 to 403 are graphs representing the relationship between the total travel distance of the candidate vehicle and the parameters y1 to y3 regarding the elevation difference influence index value, the travel time influence index value, and the influence index value of number of passengers, respectively. Graph 404 is a graph representing the relationship between the total travel distance of the candidate vehicle and the item priority related to durability in the case where the individual influence index values are relatively small. Further, Graph 405 is a graph representing the relationship between the total travel distance of the candidate vehicle and the item priority related to durability in a case where the individual influence index values are relatively larger than those in the graph 404. As shown in the graphs 401 to 403, as the total travel distance is longer, the values of the parameters y1 to y3 increase with respect to the individual influence index values. As a result, as shown in the graph 404 and the graph 405, as the total travel distance is longer and the individual influence index values is larger, the item priority related to durability becomes smaller. Therefore, it can be seen that as the influence of the driving plan on the decrease in durability is higher, or the total travel distance of the candidate vehicle is longer, the item priority related to durability becomes smaller.

For each candidate vehicle, the priority setting unit 43 sets the weighted sum of the individual item priorities set for the candidate vehicle as the final priority for the candidate vehicle. The weighting factors for each item priority may all be the same, or the weighting factor for any item may be greater than the weighting factors for other items. For example, the weight coefficient of the item priority related to the safety of the vehicle may be set to be larger than the weight coefficients of the item priorities related to the other items. Alternatively, the weight coefficient of the item priority related to durability may be set to be larger than the weight coefficients of the item priorities related to the other items. Then, the priority setting unit 43 notifies the dispatched vehicle determination unit 44 of the priority set for each candidate vehicle.

The dispatch vehicle determination unit 44 determines a vehicle to be dispatched from among the candidate vehicles based on the priority set for each candidate vehicle. In the present embodiment, the dispatched vehicle determination unit 44 determines the candidate vehicle having the highest priority among the candidate vehicles as the vehicle to be dispatched. When a signal indicating that the vehicle cannot be picked up is received from the vehicle to which the server 3 has transmitted the pick-up instruction, the dispatched vehicle determination unit 44 determines the candidate vehicle having the next higher priority as the vehicle to be dispatched.

The dispatch vehicle determination unit 44 notifies the pickup instruction unit 45 of the identification information of the vehicle to be dispatched.

The pickup instruction unit 45 generates a pick-up instruction including the planned boarding location and the planned getting-out location included in the dispatch request for the vehicle specified by the identification information notified from the dispatched vehicle determination unit 44. The pickup instruction unit 45 transmits the generated pick-up instruction to the vehicle to be dispatched via the communication interface 31, the communication network 4, and the wireless base station 5. Note that the pick-up instruction may further include information indicating at least one of the identification information of the user who has transmitted the dispatch request, the planned traveling route to the planned boarding location, and the planned traveling route to the planned getting-out location.

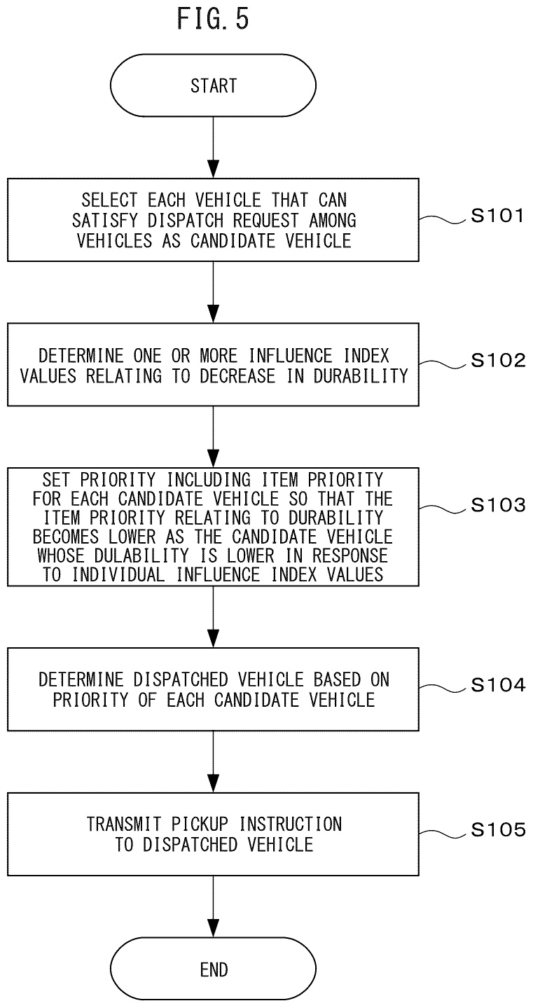

FIG. 5 is an operation flowchart of the dispatch management process. Each time the dispatch request is received, the processor 34 executes the dispatch management process according to the operation flowchart shown below.

The selection unit 41 selects one or more vehicles that can satisfy the dispatch request from among the plurality of vehicles 2-1 to 2-n as candidate vehicles (step S101). Based on the driving plan included in the dispatch request, the influence index determination unit 42 determines one or more influence index values representing the influence degree on the decrease in durability (step S102). Further, the priority setting unit 43 sets, for each candidate vehicle, a priority including an item priority related durability such that the item priority related durability becomes lower as the durability of the candidate vehicle represented by the durability index of the candidate vehicle is lower in accordance with the individual influence index values (step S103). The vehicle dispatch determining unit 44 determines the vehicle to be dispatched from among the candidate vehicles based on the priorities set for the respective candidate vehicles (step S104). The pickup instruction unit 45 transmits a pick-up instruction to the vehicle to be dispatched via the communication network 4 or the like (step S105). Then, the processor 34 terminates the dispatch management process.

As described above, as a reference for determining a vehicle to be dispatched, the dispatch management device sets the priority level of each candidate vehicle so that the priority level becomes lower as the influence of the decrease in durability due to the driving plan is larger or the durability of the candidate vehicle is lower. Therefore, the dispatch management device can determine the vehicle to be dispatched from among the candidate vehicles so that the vehicle having no durability problem is easily dispatched to the user who has the driving plan in which the decrease in durability is a concern.

According to the modification, with respect to each influence index value, the influence index determination unit 42 may set the influence index value used for the candidate vehicle that is Battery Electric Vehicle (BEV) to be larger than the influence index value used for the candidate vehicle other than BEV. Thus, if the durability index of the candidate vehicle as BEV and the durability index of the candidate vehicle other than BEV are the same, the item priority related to durability of the candidate vehicle as BEV is smaller than the item priority related to the candidate vehicle other than BEV. This makes it more difficult to dispatch BEV candidate vehicle, which have a greater impact on the decrease in durability due to the reason that the engine brakes cannot be used, in response to a dispatch request having a driving plan in which the decrease in durability is feared.

According to another modification, instead of the total travel distance, the number of days since the manufacturing date or the registration date of the candidate vehicle or the total number of times of acceleration and deceleration from the manufacturing date or the registration date may be used as the durability index of each candidate vehicle. That is, it is supposed that as the number of days that the candidate vehicle has elapsed since the manufacturing date or the registration date is longer or the total number of accelerations and decelerations is larger, the durability of the candidate vehicle becomes lower. In this case as well, the priority setting unit 43 may calculate the item priority related to durability according to Equation (2). In addition, the parameters y1 to y3 may be determined according to a function or a table as in the above-described embodiment. That is, the item priority is set so that the item priority related to durability becomes lower as the number of elapsed days increases or the total number of acceleration/deceleration times increases. In order to obtain the total number of times of acceleration and deceleration of the respective candidate vehicles, the ECU of each of the vehicles 2-1 to 2-n counts the number of times that the absolute value of acceleration or deceleration exceeds a predetermined threshold value while the ignition switch is turned on, and when the ignition switch is turned off, the number of times and the vehicle identification information may be transmitted to the server 3 via the wireless communication terminal. The processor 34 of the server 3 may refer to the identification information of the vehicle and add the received number of times to the total acceleration/deceleration number of the vehicle stored in the storage device 32.

According to yet another variant, the planned traveling route itself may not be included in the driving plan. In this case, the influence index determination unit 42 of the processor 34 of the server 3 may refer to the map information to obtain the planned traveling route from the planned boarding location to the planned getting-out location according to a predetermined route search method such as the Dijkstra method.

The computer program that causes the computer to execute the processing executed by the processor 34 of the server 3 may be distributed by being recorded on a recording medium such as an optical recording medium or a magnetic recording medium.

As described above, a skilled person can make various modifications according to the embodiment within the scope of the present disclosure.

What is claimed is:

1. A dispatch management device comprising:
a processor configured to:
determine an influence index value representing an influence degree on a decrease in durability based on a driving plan included in a dispatch request,
set a priority for each of a plurality of candidate vehicles so that the priority becomes lower, as durability of the candidate vehicle represented by a durability index of the candidate vehicle is lower, in response to the influence index value, and
determine a vehicle to be dispatched from among the plurality of candidate vehicles in response to the priority of each of the plurality of candidate vehicles.

2. The dispatch management device according to claim 1, wherein the durability index of each of the plurality of candidate vehicles includes a total travel distance, and for each of the plurality of candidate vehicles, the processor lowers the priority of the candidate vehicle as the total travel distance of the candidate vehicle is longer.

3. The dispatch management device according to claim 1, wherein the processor determines the influence index value so that the priority becomes lower as an elevation difference or a gradient in a planned traveling route indicated by the driving plan is larger.

4. The dispatch management device according to claim 1, wherein the processor determines the influence index value so that the priority becomes lower as a difference between a target arrival time and a scheduled departure time indicated by the driving plan is smaller.

5. The dispatch management device according to claim 1, wherein the processor determines the influence index value such that the priority is lower as an expected number of passengers indicated by the driving plan increases.
